(19) United States
(12) Patent Application Publication
(10) Pub. No.: US 2025/0039006 A1
(43) Pub. Date: Jan. 30, 2025

(54) MANAGEMENT CONTROLLER, DEVICE COMMUNICATION SYSTEM, COMMUNICATION METHOD, AND RECORDING MEDIUM

(71) Applicant: Mitsubishi Electric Corporation, Tokyo (JP)

(72) Inventors: Tatsuya YAMAMOTO, Tokyo (JP); Hidetaka KATO, Tokyo (JP)

(73) Assignee: Mitsubishi Electric Corporation, Tokyo (JP)

(21) Appl. No.: 18/716,808

(22) PCT Filed: Jun. 7, 2022
(86) PCT No.: PCT/JP2022/022921

§ 371 Date: Jun. 6, 2024

(51) Int. Cl. H04L 12/18; H04W 72/0446

(52) U.S. Cl. CPC H04L 12/18; H04W 72/0446

(57) ABSTRACT

A management controller for performing cyclic communication using time-sensitive networking (TSN) with a time-sharing method includes a communicator that communicates, in communication during one period in the time-sharing method, with a first device incompatible with multicast communication in a first time slot and with a second device compatible with multicast communication in a second time slot, and a transferrer that transfers, with the communicator, to the second device in the second time slot, data received by the communicator from the first device in the first time slot.

### TECHNICAL FIELD

The present disclosure relates to a management controller, a device communication system, a communication method, and a program.

### BACKGROUND ART

A network used in factory automation (FA) typically includes an inter-controller network and a field network. In the inter-controller network, a management controller that centrally controls the network communicates with general controllers serving as control devices. In the field network, the management controller communicates with input-output devices. Typically, the field network uses unicast communication as a communication method for transmitting data to a single device, whereas the inter-controller network uses multicast communication as a communication method for transmitting data to multiple devices at the same time, with input-output devices being typically compatible with unicast communication alone and incompatible with multicast communication.

Some techniques perform inter-device communication in a single network without using the inter-controller network and the field network. Patent Literature 1 describes a data collection system including a master device and slave devices (collectively referred to as communication devices) that are highly synchronized with each other to perform cyclic communication and a data collection management device that collects data acquired in the cyclic communication. The system includes a cyclic communication period for updating data using multicast and a noncyclic communication period for updating data using unicast. This allows, in a single network, inter-device communication between the communication devices compatible with multicast communication and the data collection management device incompatible with multicast communication.

### CITATION LIST

### Patent Literature

Patent Literature 1: Japanese Patent No. 6836692

### SUMMARY OF INVENTION

### Technical Problem

The data collection system in Patent Literature 1 performs cyclic communication to update data using multicast and can thus collect data from the communication devices compatible with multicast communication alone. Thus, for example, the data collection system in Patent Literature 1 cannot easily collect data from input-output devices. As described above, the input-output devices are typically incompatible with multicast communication. The data collection system in Patent Literature 1 is thus less user-friendly.

Under such circumstances, an objective of the present disclosure is to provide a management controller that is user-friendly when used in a network including devices compatible with multicast communication and devices incompatible with multicast communication.

### Solution to Problem

To achieve the above objective, a management controller according to the present disclosure is a management controller for performing communication using time-sensitive networking (TSN) with a time-sharing method. The management controller includes communication means for communicating, in communication during one period in the time-sharing method, with a first device in a first time slot and with a second device in a second time slot, the first device being incompatible with multicast communication, the second device being compatible with multicast communication, and transfer means for transferring, with the communication means, to the second device in the second time slot, data received by the communication means from the first device in the first time slot.

### Advantageous Effects of Invention

According to the present disclosure, a management controller can be provided that is user-friendly when used in a network including devices compatible with multicast communication and devices incompatible with multicast communication.

### BRIEF DESCRIPTION OF DRAWINGS

FIG. 1 illustrates overall configuration of a device communication system according to an embodiment of the present disclosure;

FIG. 2 is a sequence diagram illustrating an example of cyclic communication in the device communication system according to the embodiment of the present disclosure;

FIG. 3 illustrates functional configuration of a management controller according to the embodiment of the present disclosure:

FIG. 4 illustrates an example cyclic memory in the management controller according to the embodiment of the present disclosure:

FIG. 5 illustrates an example of hardware configuration of the management controller according to the embodiment of the present disclosure:

FIG. 6 is a flowchart for explanation of an example of a device identification operation performed by the management controller according to the embodiment of the present disclosure; and

FIG. 7 is a flowchart for explanation of an example of a device communication operation performed by the management controller according to the embodiment of the present disclosure.

### DESCRIPTION OF EMBODIMENTS

A device communication system according to one or more embodiments of the present disclosure is described with reference to the drawings. In the figures, like reference signs denote like or corresponding components.

### EMBODIMENT

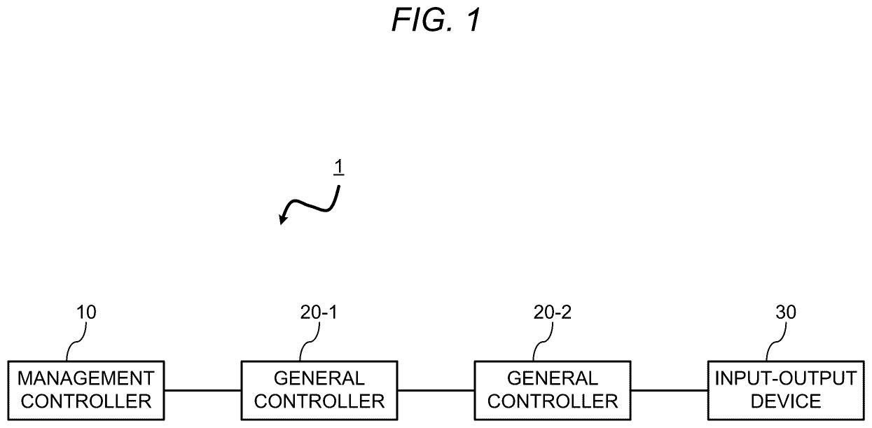

A device communication system 1 according to an embodiment is described with reference to FIG. 1. The device communication system 1 is, for example, a device communication system installed in a factory network. The device communication system 1 includes a management controller 10, one or more general controllers 20, and one or more input-output devices 30. FIG. 1 illustrates two general controllers 20 and one input-output device 30. The two general controllers 20 are referred to as a general controller 20-1 and a general controller 20-2. The general controller 20-1 and the general controller 20-2 may be hereafter simply referred to as the general controllers 20 without being distinguished from each other. In FIG. 1, the network is a line network. In some embodiments, the network may be a bus network, a star network, or a network including multiple types of networks. The device communication system 1 is an example of a device communication system according to the present disclosure.

The management controller 10, the general controllers 20, and the input-output device 30 may be hereafter collectively referred to as devices.

In the device communication system 1, the devices perform cyclic communication using time-sensitive networking (TSN) with a time-sharing method. To perform cyclic communication, the devices are highly synchronized under a time synchronization protocol. In the device communication system 1, the management controller 10 communicates with the general controllers 20 using multicast and with the input-output device 30 using unicast. The general controllers 20 cannot directly communicate with the input-output device 30. Although the management controller 10 and the general controllers 20 are compatible with multicast communication, the input-output device 30 is incompatible with multicast communication. Being incompatible with multicast communication herein refers to being unable to transmit data to multiple devices at the same time and also being unable to process frames transmitted using multicast.

The management controller 10 and the general controllers 20 are, for example, programmable logic controllers. The input-output device 30 is, for example, a sensor or an actuator. The functional components of the management controller 10 are described later. The management controller 10 is an example of a management controller according to the present disclosure. Each general controller 20 is an example of a general controller or a second device in the present disclosure. The input-output device 30 is an example of an input-output device or a first device in the present disclosure.

As described above, the general controllers 20 cannot directly communicate with the input-output device 30. Thus, to control the input-output device 30, the general controllers 20 communicate with the management controller 10, and the management controller 10 communicates with the input-output device 30 based on the communication between the general controllers 20 and the management controller 10.

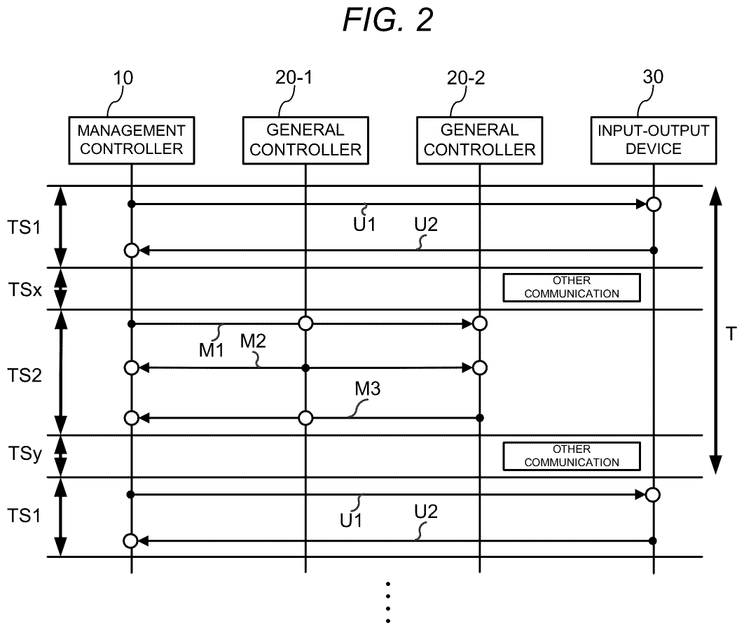

An example of cyclic communication in the device communication system 1 is described with reference to FIG. 2. The devices perform cyclic communication with a period T as one unit. Communication during one period at least includes unicast communication to be performed in a first time slot TS1 and multicast communication to be performed in a second time slot TS2. Other communication may be performed in a third time slot TSx or a fourth time slot TSy. Other communication is, for example, noncyclic communication performed independently of the cyclic communication. The third time slot TSx and the fourth time slot TSy may be eliminated. In the example described in detail below, the period T includes no third time slot TSx and no fourth time slot TSy.

The management controller 10 first transmits data to the input-output device 30 using unicast (step U1). The input-output device 30 transmits data to the management controller 10 using unicast (step U2). The unicast communication in steps U1 and U2 is performed in the first time slot TS1.

The management controller 10 then transmits the data to the general controllers 20 at the same time using multicast (step M1). The general controllers 20 each transmit data to the management controller 10 and the other general controller 20 using multicast (steps M2 and M3). The multicast communication in steps M1, M2 and M3 is performed in the second time slot TS2. In this state, the unicast communication and the multicast communication to be performed during one period of cyclic communication are complete.

As described above, the management controller 10 first communicates with the input-output device 30 using unicast in the first time slot TS1 and then communicates with the general controllers 20 using multicast in the second time slot TS2 during one period of cyclic communication. The management controller 10 can thus transmit the data received from the input-output device 30 to the general controllers 20 during one period of the cyclic communication. The manner in which the data received from the input-output device 30 is transmitted to the general controllers 20 is specifically described later.

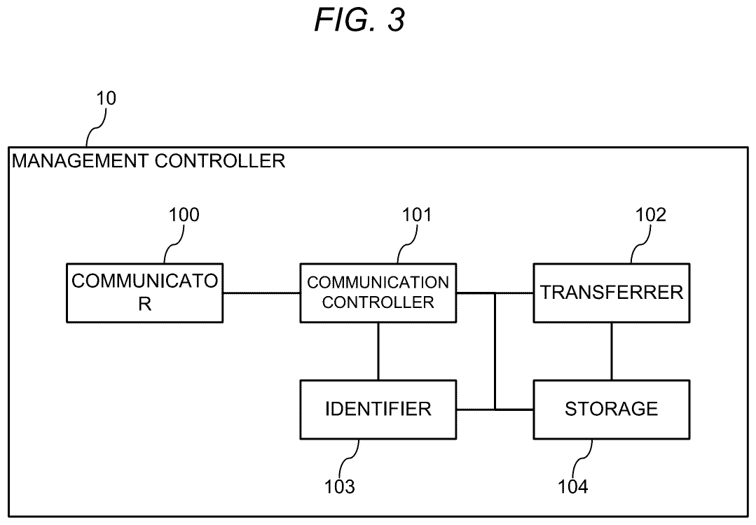

The functional components of the management controller 10 are described with reference to FIG. 3. The management controller 10 includes a communicator 100, a communication controller 101, a transferrer 102, an identifier 103, and a storage 104.

The communicator 100 performs, based on the control performed by the communication controller 101, unicast communication with the input-output device 30 and performs multicast communication with the general controllers 20. The communicator 100 is an example of communication means in the present disclosure.

The communication controller 101 determines the time slot including the current time in the cyclic communication and performs communication control based on the time slot. When, for example, the current time is included in the first time slot TS1 in FIG. 2, the communication controller 101 controls the communicator 100 to communicate with the input-output device 30 using unicast. When the current time is included in the second time slot TS2 in FIG. 2, the communication controller 101 controls the communicator 100 to communicate with the general controllers 20 using multicast.

The communication controller 101 outputs data received by the communicator 100 to the transferrer 102 described later. The communication controller 101 controls the communicator 100 based on data output by the transferrer 102 to the communication controller 101. As described in detail later, the management controller can thus transfer data transmitted by the input-output device 30 to the management 10 controller 10 using unicast to the general controllers 20 using multicast. Similarly, the management controller 10 can transfer data transmitted by the general controllers 20 to the management controller 10 using multicast to the input-output device 30 using unicast.

The communication controller 101 determines, with the identifier 103 described later, for each of the devices in the device management system 1, either as a device compatible with multicast or as a device incompatible with multicast, and performs communication control based on the determination results.

The transferrer 102 stores the data received by the communicator 100 and output by the communication controller 101 into a cyclic memory in the storage 104 with a method described later. The transferrer 102 reads the data from the cyclic memory in the storage 104 and outputs the data to the communication controller 101. This allows data to be transferred from the input-output device 30 to the general controllers 20 and from the general controllers 20 to the input-output device 30. The transferrer 102 is an example of transfer means in the present disclosure.

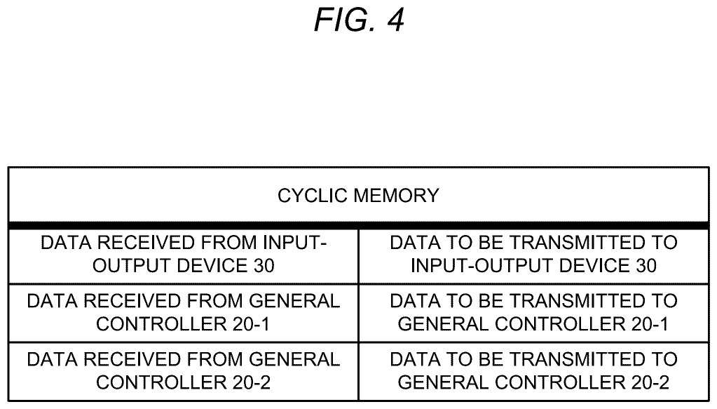

The cyclic memory in the storage 104 is described below with reference to FIG. 4. As illustrated in FIG. 4, the cyclic memory separately stores data pieces received from the devices and data pieces to be transmitted to the devices. The transferrer 102 stores data pieces received by the communicator 100 and output by the communication controller 101 into the cyclic memory for each device as a transmission source.

The transferrer 102 reads, of the data pieces stored in the cyclic memory, a data piece to be transmitted to a destination device and outputs the data piece to the communication controller 101. The destination device is either the input-output device 30 or one of the general controllers 20 as appropriate for the time slot including the current time in the cyclic communication. Thus, the data piece to be transmitted to the destination device also differs as appropriate for the time slot including the current time in the cyclic communication.

When, for example, the current time is in the first time slot TS1 and communication with the input-output device 30 is performed using unicast, the transferrer 102 outputs, to the communication controller 101, a data piece to be transmitted to the input-output device 30, a data piece received from the general controller 20-1, and a data piece received from the general controller 20-2. Similarly, when the current time is in the second time slot TS2 and communication with the general controllers 20 is performed using multicast, the transferrer 102 outputs, to the communication controller 101, a data piece received from the input-output device 30, a data piece to be transmitted to the general controller 20-1, and a data piece to be transmitted to the general controller 20-2.

The identifier 103 identifies each of devices to be communication targets of the management controller 10 either as a device compatible with multicast communication or as a device incompatible with multicast communication. The identifier 103 broadcasts, for example, a connected device detection frame to all the devices, and identifies, based on device information as a response from each device to the connected device detection frame, the device either as a device compatible with multicast communication or a device incompatible with multicast communication. The device information includes, for example, information indicating compatibility or incompatibility with multicast communication. The device information as a response from each general controller 20 includes information indicating compatibility with multicast. The device information as a response from the input-output device 30 includes information indicating incompatibility with multicast.

The identifier 103 stores information indicating the identification results into the storage 104. The communication controller 101 refers to the information indicating the identification results stored in the storage 104. When the current time is included in the first time slot TS1, the communication controller 101 performs unicast communication with a device(s) incompatible with multicast communication as a communication target(s). When the current time is included in the second time slot TS2, the communication controller 101 performs multicast communication with a device(s) compatible with multicast communication as a communication target(s). The identifier 103 is an example of identification means in the present disclosure.

The storage 104 stores the information in the cyclic memory described above and the information indicating the identification results acquired with the identifier 103.

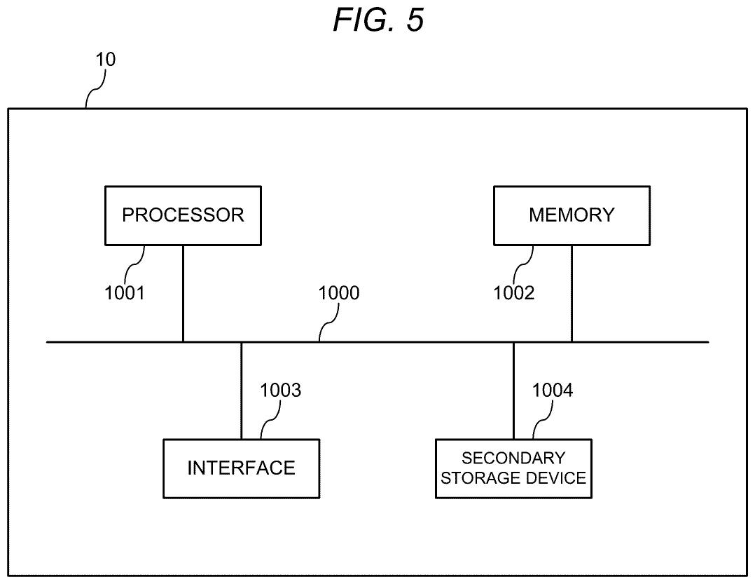

An example hardware configuration of the management controller 10 is described with reference to FIG. 5. The management controller 10 illustrated in FIG. 5 is implemented by, for example, a computer such as a personal computer or a microcontroller.

The management controller 10 includes a processor 1001, a memory 1002, an interface 1003, and a secondary storage device 1004 that are connected to one another with a bus 1000.

The processor 1001 is, for example, a central processing unit (CPU). The functions of the management controller 10 are implemented by the processor 1001 loading the operating program stored in the secondary storage device 1004 into the memory 1002 and executing the operating program.

The memory 1002 is a main storage device including, for example, a random-access memory (RAM). The memory 1002 stores the operating program loaded by the processor 1001 from the secondary storage device 1004. The memory 1002 serves as a working memory when the processor 1001 executes the operating program. The memory 1002 implements the functions of the storage 104.

The interface 1003 is an input-output (I/O) interface, such as a serial port, a universal serial bus (USB) port, or a network interface. The interface 1003 implements the functions of the communicator 100.

The secondary storage device 1004 is, for example, a flash memory, a hard disk drive (HDD), or a solid-state drive (SSD). The secondary storage device 1004 stores the operating program to be executed by the processor 1001.

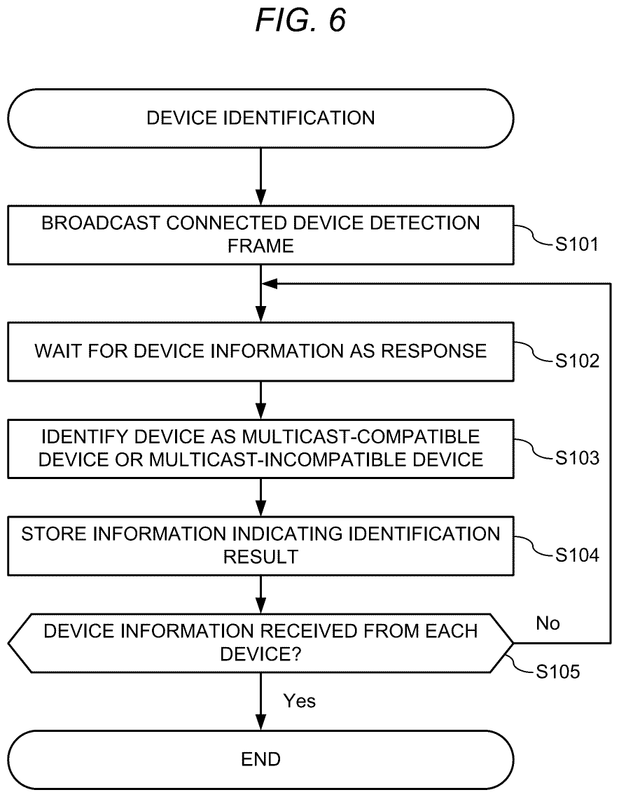

An example device identification operation performed by the management controller 10 is described with reference to FIG. 6. Device identification refers to identifying each device either as a device compatible with multicast communication or as a device incompatible with multicast communication. The operation illustrated in FIG. 6 is performed when, for example, the device communication system 1 is newly installed.

The identifier 103 in the management controller 10 broadcasts the connected device detection frame to all the devices to be communication targets (step S101).

The identifier 103 waits for the communicator 100 to receive device information as a response to the connected device detection frame (step S102).

When the communicator 100 receives device information as a response in step S102, the identifier 103 identifies the responding device as a device compatible with multicast communication or as a device incompatible with multicast communication based on the device information (step S103).

The identifier 103 stores information indicating the identification result acquired in step S103 into the storage 104 (step S104).

The identifier 103 determines whether device information has been received from each device to be the communication target (step S105). When device information has yet to be received from each device (No in step S105), the identifier 103 repeats the operation in step S102 and subsequent steps. When device information has been received from each device (Yes in step S105), the identifier 103 ends the device identification operation.

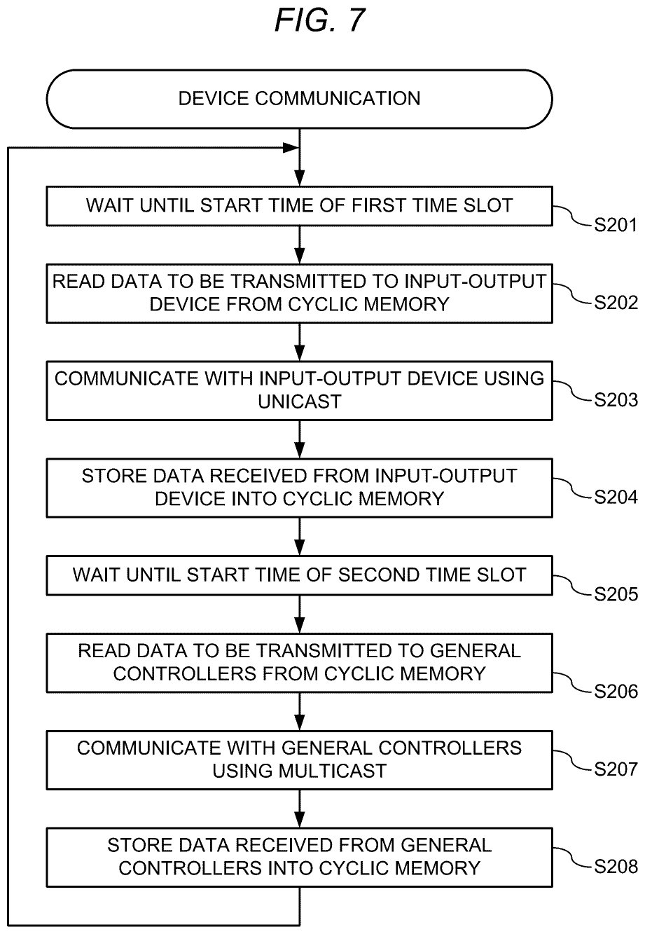

An example device communication operation performed by the management controller 10 is described with reference to FIG. 7. The operation illustrated in FIG. 7 is performed, for example, after the operation illustrated in FIG. 6 is performed.

The communication controller 101 in the management controller 10 waits until the current time reaches the start time of the first time slot TS1 (step S201).

When the current time reaches the start time of the first time slot TS1 in step S201, the transferrer 102 reads, from the cyclic memory in the storage 104, data to be transmitted to the input-output device 30 (step S202). The read data is output to the communication controller 101.

The communication controller 101 controls the communicator 100 to communicate with the input-output device 30 using unicast (step S203). The data read in step S202 is transmitted to the input-output device 30 in step S203.

The transferrer 102 stores data received by the communicator 100 from the input-output device 30 in step S203 into the cyclic memory in the storage 104 (step S204).

The communication controller 101 waits until the current time reaches the start time of the second time slot TS2 (step S205).

When the current time reaches the start time of the second time slot TS2 in step S205, the transferrer 102 reads, from the cyclic memory in the storage 104, data to be transmitted to the general controllers 20 (step S206). The read data is output to the communication controller 101.

The communication controller 101 controls the communicator 100 to communicate with the general controllers 20 using multicast (step S207). The data read in step S206 is transmitted to the general controllers 20 in step S207.

The transferrer 102 stores data received by the communicator 100 from the general controllers 20 in step S207 into the cyclic memory in the storage 104 (step S208).

The communication controller 101 then repeats the operation in step S201 and subsequent steps.

In the device communication system 1 according to the embodiment described above, the management controller 10 transfers data received from the devices with the transferrer 102 in an appropriate manner at appropriate timing. The device communication system 1 is thus user-friendly when used in a network including devices compatible with multicast communication and devices incompatible with multicast communication. For example, the device communication system 1 allows a user to transmit data from the input-output device 30 incompatible with multicast communication to the general controllers 20 compatible with multicast communication without creating a dedicated program, and is thus user-friendly.

### Modifications

In the hardware configuration illustrated in FIG. 5, the management controller 10 includes the secondary storage device 1004. However, the secondary storage device 1004 may be external to the management controller 10, and the management controller 10 and the secondary storage device 1004 may be connected to each other with the interface 1003. In this configuration, the secondary storage device 1004 may be a removable medium such as a USB flash drive or a memory card.

In place of the hardware configuration illustrated in FIG. 5, the management controller 10 may have a dedicated circuit including an application-specific integrated circuit (ASIC) or a field-programmable gate array (FPGA). In the hardware configuration illustrated in FIG. 5, some functions of the management controller 10 may be implemented by, for example, a dedicated circuit connected to the interface 1003.

The program used in the management controller 10 may be stored in a non-transitory computer-readable recording medium, such as a compact disc read-only memory (CD-ROM), a digital versatile disc (DVD), a USB flash drive, a memory card, or an HDD, and may then be distributed. A specific computer or a general-purpose computer on which the program is installed can function as the management controller 10.

The program may be stored in a storage device in another server on the Internet and may be downloaded from the server.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Device communication system
10 Management controller
20, 20-1, 20-2 General controller
30 Input-output device
100 Communicator
101 Communication controller
102 Transferrer
103 Identifier
104 Storage
1000 Bus
1001 Processor
1002 Memory
1003 Interface
1004 Secondary storage device
TS1 First time slot
TS2 Second time slot
TSx Third time slot
TSy Fourth time slot

1. A management controller for performing cyclic communication using time-sensitive networking with a time-sharing method, the management controller comprising:
a communicator; and
processing circuitry to
communicate, with the communicator, in communication during one period in the time-sharing method, with a first device in a first time slot and with a second device in a second time slot, the first device being incompatible with multicast communication, the second device being compatible with multicast communication, and
transfer, with the communicator, to the second device in the second time slot, data received by the communicator from the first device in the first time slot.

2. The management controller according to claim 1, wherein
the first device is an input-output device, and the second device is a general controller to control the input-output device, and
in the communication during the one period, communication in the first time slot is performed before communication in the second time slot.

3. The management controller according to claim 2, wherein the processing circuitry performs noncyclic communication in a third time slot after the first time slot and before the second time slot.

4. The management controller according to claim 1, wherein
the processing circuitry identifies, as the first device or the second device, a device to be a communication target of the communicator.

5. The management controller according to claim 4, wherein
the processing circuitry broadcasts, with the communicator, a connected device detection frame to the device to be the communication target and identifies, as the first device or the second device, the device to be the communication target, based on device information that is a response from the device to be the communication target to the connected device detection frame.

6. A device communication system, comprising:
the management controller according to claim 1;
the first device; and
the second device.

7. A communication method for performing cyclic communication using time-sensitive networking with a time-sharing method, the communication method comprising:
communicating, in communication during one period in the time-sharing method, with a first device in a first time slot and with a second device in a second time slot, the first device being incompatible with multicast communication, the second device being compatible with multicast communication; and
transferring, to the second device in the second time slot, data received from the first device in the first time slot.

8. A non-transitory computer-readable recording medium storing a program for causing a computer to implement the communication method according to claim 7.

9. The management controller according to claim 2, wherein
the processing circuitry identifies, as the first device or the second device, a device to be a communication target of the communicator.

10. The management controller according to claim 3, wherein
the processing circuitry identifies, as the first device or the second device, a device to be a communication target of the communicator.

11. The management controller according to claim 9, wherein
the processing circuitry broadcasts, with the communicator, a connected device detection frame to the device to be the communication target and identifies, as the first device or the second device, the device to be the communication target, based on device information that is a response from the device to be the communication target to the connected device detection frame.

12. The management controller according to claim 10, wherein
the processing circuitry broadcasts, with the communicator, a connected device detection frame to the device to be the communication target and identifies, as the first device or the second device, the device to be the communication target, based on device information that is a response from the device to be the communication target to the connected device detection frame.

13. A device communication system, comprising:
the management controller according to claim 2;
the first device; and
the second device.

14. A device communication system, comprising:
the management controller according to claim 3;
the first device; and
the second device.
